(19) United States
(12) Patent Application Publication
(10) Pub. No.: US 2016/0077211 A1
(43) Pub. Date: Mar. 17, 2016

(54) METHOD AND SYSTEM FOR DYNAMIC-TO-DYNAMIC PRECISE RELATIVE POSITIONING USING GLOBAL NAVIGATION SATELLITE SYSTEMS

(71) Applicant: Fugro N.V., Leidschendam (NL)

(72) Inventor: Liu XIANGLIN, Leidschendam (NL)

(21) Appl. No.: 14/857,471

(22) Filed: Sep. 17, 2015

(30) Foreign Application Priority Data
Sep. 15, 2014 (NL) 2013471

(51) Int. Cl. G01S 19/07

(52) U.S. Cl. CPC G01S 19/07

(57) ABSTRACT

Global Navigation Satellite (GNS) signal correction system (2) for estimating and transmitting GNSS signal corrections (A) to a mobile station (30). A method is implemented for providing correction data in a Global Navigation Satellite System (GNSS) based Precise Relative Positioning (PRP) system. The correction data is determined using one or more reference stations, and transmitted to a mobile station with a primary update frequency. The correction data comprises one or more subgroups of correction data (B, I, T), and the one or more subgroups of correction data (B, I, T) are transmitted with a mutually different secondary update frequency (f₁, f₂, f₃). Also a mobile station (30) is described using the present invention embodiments.

### CROSS REFERENCE TO RELATED APPLICATIONS

This application claims priority from Dutch Patent Application No. 2013471, filed Sep. 15, 2014, the contents of which are entirely incorporated by reference herein.

### TECHNICAL FIELD

The present invention relates to a method for providing correction data in a Global Navigation Satellite System (GNSS) based Precise Relative Positioning (PRP) system, the method comprising determining the correction data using one or more (dynamic) reference stations, transmitting the correction data to a mobile station with a primary update frequency, and applying the correction data in mobiles for precise relative positioning.

### BACKGROUND

Traditional precise relative positioning using global navigation satellite systems is known as such, see textbooks such as ‘GPS for Geodesy’ by P. J. G. Teunissen and A. Kleusberg (eds), 2^{nd} ed., Springer, 1998.

### SUMMARY OF INVENTION

The present invention seeks to provide an improved method and system for providing precise relative positioning using satellite navigation systems in a fully dynamic situation.

According to the present invention, a method as defined above is provided, wherein the correction data used for precise relative positioning comprises three different groups: stable correction, i.e. hardware delay bias (B), non-dispersive correction, i.e. troposphere (T), and dispersive correction, i.e. ionosphere (I). The one or more subgroups of correction data are transmitted with a mutually different secondary update frequency. This implementation saves on bandwidth requirements from the one or more reference stations to the mobile station, or in other words, the capacity requirements on the mobile station can be lower (e.g. use a low data rate channel, ability to better handle poor reception conditions, allow a longer distance to the mobile station, etc.).

It is noted that both reference and mobile stations may be in a dynamic situation, not limited to the traditional case that the reference stations are static with known coordinates. The implementation is particularly useful for some offshore/ocean engineering operations, such as seismic surveying, platform installation and pipelining engineering. The implementation can provide precise relative positioning for take-off and landing of aircraft on carrier, and for vehicle to vehicle tracking.

In a further aspect, the present invention relates to a Global Navigation Satellite (GNS) signal correction system for estimating and transmitting GNS signal corrections to a mobile receiver. The GNS signal correction system comprises one or more dynamic reference stations having a system GNSS receiver for acquiring GNSS data comprising pseudo range system observations (Pₐ) and carrier phase system observations (Φₐ) from a plurality of GNSS satellites transmitted over multiple epochs, a system processor unit configured for receiving the GNSS data from the one or more reference stations in real time, and calculating correction data. A system signal transmitter is provided connected to the system processor unit for transmitting the correction data to the mobile station. The system processor unit is configured to execute the present invention method embodiments, and allows the GNSS signal correction system to service multiple mobile stations in a local range area.

In an even further aspect, the present invention relates to a mobile receiver for use with GNS signal correction system. The mobile station comprises a mobile GNSS receiver for acquiring GNSS data comprising pseudo range mobile observations (Pᵣ) and carrier phase mobile observations (Φᵣ) from the plurality of GNSS satellites transmitted over multiple epochs, and a mobile signal receiver for receiving GNSS corrections. The mobile station further comprises a mobile processing unit connected to the mobile GNSS receiver and the mobile signal receiver. The mobile processing unit is arranged to use correction data being transmitted according to any one of the present invention method embodiments. Subgroups of correction data are thus used by the mobile station, which are received at different interval times. If an indication is received from the GNS signal correction system that a precise position was not available for an epoch, the sum of correction data may be used in order to obtain an accurate relative position.

### BRIEF DESCRIPTION OF DRAWINGS

Embodiments will now be described, by way of example only, with reference to the accompanying schematic drawings in which corresponding reference symbols indicate corresponding parts.

FIG. 1 shows a schematic diagram of an exemplary GNSS signal correction system;

FIG. 2a shows a timing diagram of a prior art correction transmission method;

FIG. 2b shows a timing diagram of an exemplary embodiment of the present invention.

### DESCRIPTION OF EMBODIMENTS

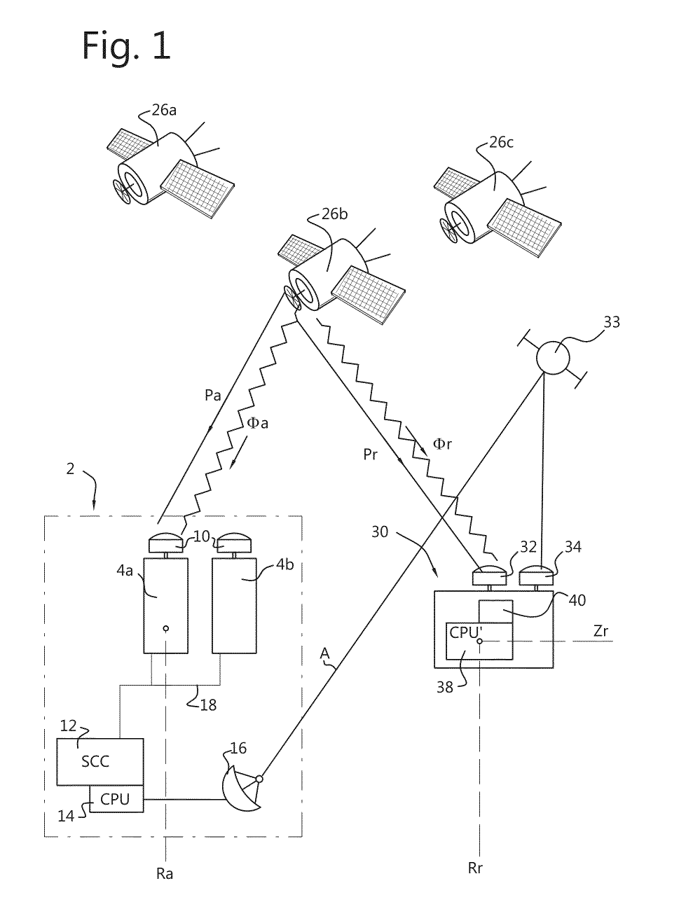

As illustrated in the schematic diagram of FIG. 1, the present invention embodiments may be implemented in a Global Navigation Satellite (GNS) signal correction system 2, in combination with a mobile station 30. The GNS signal correction system 2 comprises one or more (dynamic) reference stations, e.g. 4a, 4b with associated Global Navigation Satellite System (GNSS) antenna 10 to continuously compute site-dependent (zenith) tropospheric correction and atmospheric and hardware delay corrections of satellites from GNSS signals received from a plurality of GNSS satellites 26a-c.

Traditionally, relative positioning means position estimation of a mobile station 30 with respect to one or more reference stations 4a, 4b. The present invention embodiments do not require the positions of the reference station 4a, 4b to be known. As a matter of fact, the precise kinematic coordinates can be simultaneously calculated together with the three types of corrections mentioned above in the present invention embodiments.

Normally, in a GNSS based PRP system, the correction is computed in the observation domain and is treated as a single value and transmitted to mobile stations 30. The present invention embodiments determine corrections using a Precise Point Positioning (PPP) based GNS signal correction system 2, the obtained correction data, comprising a hardware delay bias (B), tropospheric corrections (T) and ionospheric corrections (I), are transmitted periodically as a single packet of correction data A at predefined intervals with an interval Tᵣ, i.e. with a primary update frequency fᵣ (fᵣ=1/Tᵣ), or is treated separately both in the GNS signal correction system 2 and in the mobile stations 30.

In general, a method and system for dynamic-to-dynamic precise relative positioning using global navigation satellite systems requires: GNSS signals from the plurality of GNSS satellite 26a-c. The GNS signal correction system 2, comprising one dynamic reference station or several reference stations for acquiring GNSS data comprising pseudo range system observations Pₐ and carrier phase system observations Φₐ from a plurality of GNSS satellites 26a-c transmitted over multiple epochs, a system processor unit 14 configured for collecting reference station data in real-time, for processing reference station data to generate GNSS corrections that comprises B, T and I, for encoding corrections, and for distributing encoded corrections to mobile users, real-time data links 18 between the reference stations 4a, 4b and the System Control Centre (SCC) 12, and the mobile or rover 30 configured with software for real-time processing of GNSS receiver data and PPP based GNSS corrections and for computing the precise relative positions.

Generation of Corrections from a Single (Dynamic) Reference Station

The measurement model for a code observation p and a phase observation φ at dynamic reference station a to satellite s (s=1 . . . n), at frequency i (i=1, 2), and time t, both expressed in meters, reads

p_{i,a}^{s}=Rₐ^{s}+mₐ^{s}·Tₐ+cδtₐ−cδt^{s}+γᵢIₐ^{s}+dₚ_{ᵢ}^{,a}−dₚᵢ^{s}

φ_{i,a}^{s}=Rₐ^{s}+mₐ^{s}·Tₐ+cδtₐ−cδt^{s}−γᵢI hd a^{s}+d_{φ}_{ᵢ}_{,a}−d_{φ}_{ᵢ}^{s}+λᵢN_{i,a}^{s} (1)

where Rₐ^{s} is the geometric range between reference station and satellite, Tₐ the zenith tropospheric delay with mapping function mₐ^{s}, c the speed of light, δtₐ and δt^{s} the receiver and satellite clock bias, respectively, γᵢ=f₁²/fᵢ², fᵢ the carrier frequency, Iₐ^{s} the ionospheric effect; dₚ_{ᵢ}_{,a} and d_{φ}_{ᵢ}^{,a} are the receiver hardware delays (or biases) on code and phase, respectively, dₚ_{ᵢ}^{s} and d_{φ}_{ᵢ}^{s} are the satellite hardware delays (or biases) on code and phase, respectively, where it is assumed that these satellite hardware delays are relatively stable in time, N_{i,a}^{s} the integer carrier ambiguity, and λᵢ=c/fᵢ the carrier wavelength. The measurement noise is not written in the observation equations for brevity.

The present method embodiments assume that precise predicted satellite orbits and clocks are provided. It should be mentioned that the satellite clocks are computed on the basis of ionosphere-free combinations and comprise code hardware delays (so-called code clocks). The real clock is written as follows:

\tilde{b}^{s}:=cδt^{s}+dₚ_{₃}^{s}+D (2)

### Where,

$${d}_{{p}_{3}}^{s} = \frac{{γ}_{2}}{{γ}_{2} - {γ}_{1}} {d}_{{p}_{1}}^{s} - \frac{{γ}_{1}}{{γ}_{2} - {γ}_{1}} {d}_{{p}_{2}}^{s} ,$$

D is the datum, e.g. D:=(cδt^{ref}+dₚ_{₃}^{ref}) when a reference satellite is selected as the datum, or

$$D := - \frac{1}{n} ( c δ {t}^{1} + c δ {t}^{2} + … + c δ {t}^{n} + {d}_{{p}_{3}}^{1} + {d}_{{p}_{3}}^{2} + … + {d}_{{p}_{3}}^{n} )$$

when the average of all satellite clocks is chosen as the datum.

The present method embodiments propose the following reparameterization for pseudo range and carrier phase observation equations after linearization of Eq. (1):

δ\tilde{p}_{i,a}^{s}=μₐ^{s}Δxₐ+mₐ^{s}Tₐ+tₐ+γᵢĨₐ^{s} (3)

δ\tilde{φ}_{i,a}^{s}=μₐ^{s}Δxₐ+mₐ^{s}Tₐ+tₐ−γᵢĨₐ^{s}+λᵢa_{i,a}^{s} (4)

where μₐ^{s} is is the unit vector of line-of-sight between the mobile receiver a and satellite s; δ\tilde{p}_{i,a}^{s}=p_{i,a}^{s}−Rₐ^{s}+\tilde{b}^{s}, and δ\tilde{φ}_{i,a}^{s}−Rₐ^{s}+\tilde{b}^{s}, here Rₐ^{s} is computed using precise orbit and a priori coordinates of dynamic reference station a, \tilde{b}^{s} is the precise clock; Δxₐ the correction to the a priori position. Furthermore

$$\begin{matrix} {t}_{a} := c δ {t}_{a} - \frac{{γ}_{2}}{{γ}_{1} - {γ}_{2}} {d}_{{p}_{1} , a} + \frac{{γ}_{1}}{{γ}_{1} - {γ}_{2}} {d}_{{p}_{2} , a} + D & ( 5 ) \\ {\tilde{I}}_{a}^{s} := {I}_{a}^{s} + \frac{{γ}_{1}}{{γ}_{1} - {γ}_{2}} ( {d}_{{p}_{1} , a} - {d}_{{p}_{2} , a} - {d}_{{p}_{1}}^{s} + {d}_{{p}_{2}}^{s} ) & ( 6 ) \\ {a}_{1 , a}^{s} := {N}_{1 , a}^{s} + \frac{1}{{λ}_{1}} ( {d}_{{φ}_{1} , a} - {d}_{{φ}_{1}}^{s} + \frac{{γ}_{1} + {γ}_{2}}{{γ}_{1} - {γ}_{2}} ( {d}_{{p}_{1} , a} - {d}_{{p}_{1}}^{s} ) - \frac{2 {γ}_{1}}{{γ}_{1} - {γ}_{2}} ( {d}_{{p}_{2} , a} - {d}_{{p}_{2}}^{s} ) ) & ( 7 ) \\ {a}_{2 , a}^{s} := {N}_{2 , a}^{s} + \frac{1}{{λ}_{2}} ( {d}_{{φ}_{2} , a} - {d}_{{φ}_{2}}^{s} + \frac{2 {γ}_{2}}{{γ}_{1} - {γ}_{2}} ( {d}_{{p}_{1} , a} - {d}_{{p}_{1}}^{s} ) - \frac{{γ}_{1} + {γ}_{2}}{{γ}_{1} - {γ}_{2}} ( {d}_{{p}_{2} , a} - {d}_{{p}_{2}}^{s} ) ) & ( 8 )\end{matrix}$$

The functional model for n satellites can be written as follows:

$$[ \begin{matrix}{P}_{1 , a} \\ {P}_{2 , a} \\ {Φ}_{1 , a} \\ {Φ}_{2 , a}\end{matrix} ] = [ \begin{matrix}{μ}_{a} & {M}_{a} & {e}_{n} & {γ}_{1} {I}_{n} & & \\ {μ}_{a} & {M}_{a} & {e}_{n} & {γ}_{2} {I}_{n} & & \\ {μ}_{a} & {M}_{a} & {e}_{n} & - {γ}_{1} {I}_{n} & {λ}_{1} {I}_{n} & \\ {μ}_{a} & {M}_{a} & {e}_{n} & - {γ}_{2} {I}_{n} & & {λ}_{2} {I}_{n}\end{matrix} ] [ \begin{matrix}Δ {x}_{a} \\ {T}_{a} \\ {t}_{a} \\ {I}_{a} \\ {A}_{1 , a , zd} \\ {A}_{2 , a , zd}\end{matrix} ] \\ where \\ {μ}_{a} := {( \begin{matrix}{μ}_{a}^{1} & {μ}_{a}^{2} & … & {μ}_{a}^{n}\end{matrix} )}^{T} \\ {P}_{i , a} := {( \begin{matrix}δ {\tilde{p}}_{i , a}^{1} & δ {\tilde{p}}_{i , a}^{2} & … & δ {\tilde{p}}_{i , a}^{n}\end{matrix} )}^{T} \\ {Φ}_{i , a} := {( \begin{matrix}δ {\tilde{φ}}_{i , a}^{1} & δ {\tilde{φ}}_{i , a}^{2} & … & δ {\tilde{φ}}_{i , a}^{n}\end{matrix} )}^{T} \\ {M}_{a} := {( \begin{matrix}{m}_{a}^{1} & {m}_{a}^{2} & … & {m}_{a}^{n}\end{matrix} )}^{T} \\ {e}_{n} := {( \begin{matrix}1 & 1 & … & 1\end{matrix} )}^{T} \\ {I}_{a} := {( \begin{matrix}{\tilde{I}}_{a}^{1} & {\tilde{I}}_{a}^{2} & … & {\tilde{I}}_{a}^{n}\end{matrix} )}^{T} \\ {A}_{i , a , zd} := {( \begin{matrix}{a}_{i , a}^{1} & {a}_{i , a}^{2} & … & {a}_{i , a}^{n}\end{matrix} )}^{T} \qquad ( 9 )$$

Iₙ is the n×n identity matrix. There is an option to select a reference satellite at the reference side, however it is not a must for a single site reference station.

According to the present invention embodiments, the corrections are calculated using the above described functional models. The corrections, particularly the hardware delay bias (B) are then transmitted to a mobile station 30, which then applies the corrections to fix integer ambiguities, and/or to reduce the convergence time. As an option for those mobiles being nearby the reference stations, the corrections to be transmitted may also comprise the tropospheric delay term Tₐ, and/or the ionospheric delay term Iₐ. This embodiment allows a faster convergence at the mobile station 30, as these parameters allow to constrain the ionospheric and tropospheric effects at the mobile station 30. In other words, the time needed to reliably resolve the ambiguities at the mobile station 30 is significantly shorter when using the ionospheric and tropospheric corrections.

Estimation of Corrections from a Small Network of Reference Stations

The present invention embodiments propose an approach to derive a single set of corrections from a small network of reference stations. The concept of “small” here assumes that the ionosphere and troposphere be the same for all reference stations in the network (basically the size of the network is smaller than (15−20)*(15−20) km²). The approach makes use of the advantage to form double differenced ambiguities between reference sites.

In this case, the corrections (ionosphere and hardware delay bias) are formed with respect to a reference satellite. Therefore the receiver-related hardware delays are eliminated. The observation equations for station a and satellite s with satellite n being the reference satellite can be written as:

$$\begin{matrix} δ {\tilde{p}}_{i , a}^{s} = {μ}_{a}^{s} Δ {x}_{a} + {m}_{a}^{s} T + {t}_{{p}_{i} , a} + {γ}_{i} {\tilde{I}}^{s , n} & ( 10 ) \\ δ {\tilde{φ}}_{i , a}^{s} = {μ}_{a}^{s} Δ {x}_{a} + {m}_{a}^{s} T + {t}_{{φ}_{i} , a} - {γ}_{i} {\tilde{I}}^{s , n} + {λ}_{i} {a}_{i , a}^{s , n} & ( 11 ) \\ {\tilde{I}}^{s , n} := {\tilde{I}}^{s} - {\tilde{I}}^{n} = {I}^{s} - {I}^{n} + \frac{{γ}_{1}}{{γ}_{1} - {γ}_{2}} ( - {d}_{{p}_{1}}^{s} + {d}_{{p}_{2}}^{s} + {d}_{{p}_{1}}^{n} - {d}_{{p}_{2}}^{n} ) & ( 12 ) \\ {a}_{1 , a}^{s , n} := {a}_{1 , a}^{s} - {a}_{1 , a}^{n} = {N}_{1 , a}^{s , n} - \frac{1}{{λ}_{1}} ( {d}_{{φ}_{1}}^{s , n} + \frac{{γ}_{1} + {γ}_{2}}{{γ}_{1} - {γ}_{2}} {d}_{{p}_{1}}^{s , n} - \frac{2 {γ}_{1}}{{γ}_{1} - {γ}_{2}} {d}_{{p}_{2}}^{s , n} ) & ( 13 ) \\ {a}_{2 , a}^{s , n} := {a}_{2 , a}^{s} - {a}_{2 , a}^{n} = {N}_{2 , a}^{s , n} - \frac{1}{{λ}_{2}} ( {d}_{{φ}_{2}}^{s , n} + \frac{2 {γ}_{2}}{{γ}_{1} - {γ}_{2}} {d}_{{p}_{1}}^{s , n} - \frac{{γ}_{1} + {γ}_{2}}{{γ}_{1} - {γ}_{2}} {d}_{{p}_{2}}^{s , n} ) & ( 14 ) \\ {t}_{{p}_{1} , a} := {t}_{a} + {γ}_{1} {\tilde{I}}_{a}^{n} \\ {t}_{{p}_{2} , a} := {t}_{a} + {γ}_{2} {\tilde{I}}_{a}^{n} \\ {t}_{{φ}_{1} , a} := {t}_{a} - {γ}_{1} {\tilde{I}}_{a}^{n} + {a}_{1 , a}^{n} \\ {t}_{{φ}_{2} , a} := {t}_{a} - {γ}_{2} {\tilde{I}}_{a}^{n} + {a}_{2 , a}^{n} & ( 15 )\end{matrix}$$

The observation equations for station b and satellite s with satellite n being the reference satellite can be written as:

δ\tilde{p}_{i,b}^{s}=μ_{b}^{s}Δx_{b}+m_{b}^{s}T+tₚ_{ᵢ}_{,b}+γĨ^{s,n} (16)

δ\tilde{φ}_{i,b}^{s}=μ_{b}^{a}Δx_{b}+m_{b}^{s}T+t_{φ}_{ᵢ}_{b}−γĨ^{s,n}+λᵢa_{i,b}^{s,n} (17)

The troposphere and ionosphere are the same for the two stations, and therefore are written as T and Ĩ^{s,n} respectively. In addition, mₐ^{s}=m_{b}^{s}, and it will be denoted as m^{s} in the sequel. The phase observation of station b can be reparameterized:

$$\begin{matrix}δ {\tilde{φ}}_{i , b}^{s} = {μ}_{b}^{s} Δ {x}_{b} + {m}_{b}^{s} T + {t}_{{φ}_{i} , b} - {γ}_{i} {\tilde{I}}^{s , n} + {λ}_{i} {a}_{i , a}^{s , n} + {λ}_{i} {a}_{i , b}^{s , n} - {λ}_{i} {a}_{i , a}^{s , n} \\ = {μ}_{b}^{s} Δ {x}_{b} + {m}_{b}^{s} T + {t}_{{φ}_{i} , b} - {γ}_{i} {\tilde{I}}^{s , n} + {λ}_{i} {a}_{i , a}^{s , n} + {λ}_{i} {a}_{i , a , b}^{s , n} \\ = {μ}_{b}^{s} Δ {x}_{b} + {m}_{b}^{s} T + {t}_{{φ}_{i} , b} - {γ}_{i} {\tilde{I}}^{s , n} + {λ}_{i} {a}_{i , a}^{s , n} + {λ}_{i} {N}_{i , a , b}^{s , n}\end{matrix} \\ where \\ {N}_{i , a , b}^{s , n} = {N}_{i , b}^{s} - {N}_{i , b}^{n} - {N}_{i , a}^{s} + {N}_{i , a}^{n} \qquad ( 18 )$$

is a double difference ambiguity, which should be integer.

Assuming station a as the master reference station, the observation model for one epoch is given by

$$\begin{matrix}y = Ax \\ with & ( 19 ) \\ y := {( \begin{matrix}{P}_{1 , a}^{T} & {P}_{2 , a}^{T} & {Φ}_{1 , a}^{T} & {Φ}_{2 , a}^{T} & {P}_{1 , b}^{T} & {P}_{1 , b}^{T} & {Φ}_{1 , b}^{T} & {Φ}_{2 , b}^{T}\end{matrix} )}^{T} & ( 20 ) \\ x := {( \begin{matrix}Δ {x}_{a} & Δ {x}_{b} & T & {t}_{{p}_{1} , a} & {t}_{{p}_{2} , a} & {t}_{{φ}_{1} , a} & {t}_{{φ}_{2} , a} & {t}_{{p}_{1} , b} & {t}_{{p}_{2} , b} & {t}_{{φ}_{1} , b} & {t}_{{φ}_{2} , a} & {I}_{sd}^{T} & … & … & {d}_{1 , a , sd}^{T} & {d}_{2 , a , sd}^{T} & {N}_{1 , a , b}^{T} & {N}_{2 , a , b}^{T}\end{matrix} )}^{T} & ( 21 ) \\ A := ( \begin{matrix}{μ}_{a} & & M & {e}_{n} & & & & & & & & {γ}_{1} {E}_{n \times ( n - 1 )} & … & … & & & & \\ {μ}_{a} & & M & & {e}_{n} & & & & & & & {γ}_{2} {E}_{n \times ( n - 1 )} & … & … & & & & \\ {μ}_{a} & & M & & & {e}_{n} & & & & & & - {γ}_{1} {E}_{n \times ( n - 1 )} & … & … & {λ}_{1} {E}_{n \times ( n - 1 )} & & & \\ {μ}_{a} & & M & & & & {e}_{n} & & & & & - {γ}_{2} {E}_{n \times ( n - 1 )} & … & … & & {λ}_{2} {E}_{n \times ( n - 1 )} & & \\ & {μ}_{b} & M & & & & & {e}_{n} & & & & {γ}_{1} {E}_{n \times ( n - 1 )} & … & … & & & & \\ & {μ}_{b} & M & & & & & & {e}_{n} & & & {γ}_{2} {E}_{n \times ( n - 1 )} & … & … & & & & \\ & {μ}_{b} & M & & & & & & & {e}_{n} & & - {γ}_{1} {E}_{n \times ( n - 1 )} & … & … & {λ}_{1} {E}_{n \times ( n - 1 )} & & {λ}_{1} {E}_{n \times ( n - 1 )} & \\ & {μ}_{b} & M & & & & & & & & {e}_{n} & - {γ}_{2} {E}_{n \times ( n - 1 )} & … & … & & {λ}_{2} {E}_{n \times ( n - 1 )} & & {λ}_{1} {E}_{n \times ( n - 1 )}\end{matrix} ) \\ where , {μ}_{b} := {( \begin{matrix}{μ}_{b}^{1} & {μ}_{b}^{2} & … & {μ}_{b}^{n}\end{matrix} )}^{T} \\ {P}_{i , b} := {( \begin{matrix}δ {\tilde{p}}_{i , b}^{1} & δ {\tilde{p}}_{i , b}^{2} & … & δ {\tilde{p}}_{i , b}^{n}\end{matrix} )}^{T} \\ {Φ}_{i , b} := {( \begin{matrix}δ {\tilde{φ}}_{i , b}^{1} & δ {\tilde{φ}}_{i , b}^{2} & … & δ {\tilde{φ}}_{i , b}^{n}\end{matrix} )}^{T} \\ M := {( \begin{matrix}{m}^{1} & {m}^{2} & … & {m}^{n}\end{matrix} )}^{T} \\ {e}_{n} := {( \begin{matrix}1 & 1 & … & 1\end{matrix} )}^{T} \\ {I}_{sd} := {( \begin{matrix}{\tilde{I}}^{1 , n} & {\tilde{I}}^{2 , n} & … & {\tilde{I}}^{n - 1 , n}\end{matrix} )}^{T} \\ {d}_{i , a , sd} := {( \begin{matrix}{a}_{i , a}^{1 , n} & {a}_{i , a}^{2 , n} & … & {a}_{i , a}^{n - 1 , n}\end{matrix} )}^{T} \\ {N}_{i , a , b} := {( \begin{matrix}{N}_{i , a , b}^{1 , n} & {N}_{i , a , b}^{2 , n} & … & {N}_{i , a , b}^{n - 1 , n}\end{matrix} )}^{T} \\ {E}_{n \times ( n - 1 )} := ( \begin{matrix}{I}_{n - 1} \\ {0}_{n - 1}^{T}\end{matrix} ) = ( \begin{matrix}1 & & \\ & ⋱ & \\ & & 1 \\ 0 & … & 0\end{matrix} ) & ( 22 )\end{matrix}$$

Adding more stations, e.g. c, will extend the state vector with parameters Δx_{c}, tₚ_{ᵢ}_{,c}, t_{φ}_{ᵢ}_{,c} and N_{i,c,a}. Correction terms d_{i,a,sd}, I_{sd} and T remain there and can be estimated more precisely than for the case of two stations.

According to the present invention embodiments, the corrections are calculated using the above described functional models. The corrections, particularly the hardware delay bias B (i.e. d_{i,a,sd}) are then transmitted to a mobile station 30, which applies the corrections to fix integer ambiguities, and/or to improve the convergence time. For those mobiles being nearby the reference stations, the corrections to be transmitted also comprise the ionospheric delay term I (i.e. I _{sd}) and/or the tropospheric delay term T (i.e. T). Thus, in an embodiment of the present invention, the correction data B, I, T are provided using a GNSS reference station 4a, 4b, for which the position and other parameters are estimated using a Precise Point Positioning (PPP) technique.

In view of the above, the invention can also be embodied in a GNS signal correction system 2 for estimating and transmitting GNS signal corrections A to a mobile station 30. The GNS signal correction system 2 comprises one or more reference stations 4a, 4b comprising a system GNSS receiver 10 for acquiring GNSS data comprising pseudo range system observations Pₐ and carrier phase system observations Φₐ from a plurality of GNSS satellites 26a-c transmitted over multiple epochs, a system processor unit 14 configured for receiving the GNSS data from the one or more reference stations 4a, 4b in real time, and calculating correction data A, and a system signal transmitter 16 connected to the system processor unit 14 for transmitting the correction data A to the mobile station 30. The system processor unit 14 is configured to execute the method embodiments as described herein.

### Transmission

According to the present invention embodiments, the correction data (B, I, T) are transmitted to a mobile station 30 with an update frequency. The broadcast correction data comprises one or more subgroups of correction data B, I, T, and the one or more subgroups of correction data (B, I, T) are transmitted with a mutually different secondary update frequency (f₁ . . . fₙ). As already described above, the one or more subgroups of correction data may comprise tropospheric corrections T, ionospheric corrections I, and ambiguity (or hardware delay bias) B. It is also noted that the reference stations 4a, 4b as discussed above may comprise dynamic reference stations, i.e. the exact location of the reference stations 4a, 4b may change during operation.

According to the present invention embodiments, the individual corrections (i.e. the subgroups of correction data B, I, T) are not necessarily transmitted in the same interval, as they have different stabilizations. Thus, the corrections A may comprise three different types: stable correction, i.e. hardware delay bias (B), non-dispersive correction, i.e. troposphere (T), and dispersive correction, i.e. ionosphere (I). The method of the present invention embodiments has the further advantage that the corrections of hardware delay (B) with or without the other two types of corrections I, T may be used to form pseudo-observations in mobiles for precise relative positioning. Furthermore, different constraints can be imposed in mobile stations 30 when the dispersive and non-dispersive corrections are used in a separate, non-synchronous manner. In this case, a faster or even instantaneous ambiguity-fixing can be achieved, consequently resulting in millimeter precision of baselines.

In one embodiment the secondary update frequency 1/T₃ of the hardware delay bias B is lower than the secondary update frequency 1/T₁, 1/T₂ of the tropospheric and ionospheric corrections (T, I), e.g. at least three times lower. The secondary update frequency 1/T₃ of the hardware delay bias B is e.g. less than once per twenty seconds, e.g. once per sixty seconds. In this case, the ambiguity parameters in the mobile have an integer nature and an ambiguity estimation scheme may be triggered. The secondary update frequency 1/T₁ of the tropospheric correction (T) may be at least once per thirty seconds. In this case, the tropospheric parameter in the mobile is constrained to e.g. centimeter level. The secondary update frequency 1/T₂ of the ionospheric correction parameter I is at least once per twenty seconds, e.g. once per five seconds. In this case, the ionospheric parameters in mobile are constrained to e.g. centimeter level. In a further embodiment, the secondary update frequency 1/T₂ of the ionospheric corrections (I) and the secondary update frequency 1/T₁ of the tropospheric corrections (T) are different.

The corrections B may be the most stable ones that can be transmitted in a very sparse interval (e.g. every minute). The correction T is the second stable one that can be transmitted in a relatively sparse interval (e.g. every 30 seconds). The corrections I are dispersive ones that have to be transmitted in relatively intensive interval (e.g. every 5 seconds). All these corrections do not have to be transmitted every second as required in the traditional way of precise relative positioning. This will certainly save bandwidth requirements for the transmission channel between the GNS signal correction system 2 and the mobile station 30, or in other words, requirements on the mobile receiver 30 can be lower (e.g. low data rate channel, poor signal reception capability, long distance, etc.).

It is noted that one or more of the secondary update frequencies f₁ . . . fₙ may be equal to the primary frequency fᵣ (in case two or more subgroups of correction data B, I, T, are present). Thus, in a further embodiment, an initial update interval t₁ or t₂ or t₃ of the one or more subgroups B, I, T is the same or different in a further embodiment, allowing flexible use of the transmission channel.

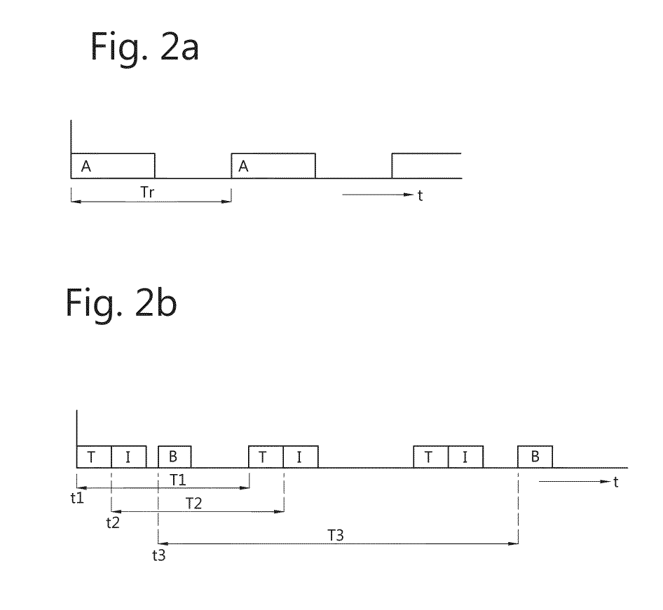

In prior art GNSS based PRP systems, the residual is treated as a single value and transmitted as correction data A to mobile stations 30. Even when determining the correction using a Precise Point Positioning (PPP) based GNSS signal correction system 2, the obtained correction data (hardware delay bias B, tropospheric corrections T and ionospheric corrections I) is transmitted periodically as a single packet of correction data A, as shown schematically in FIG. 2a, at predefined intervals with an interval Tᵣ, i.e. with a primary update frequency fᵣ (fᵣ=1/Tᵣ).

An exemplary embodiment of transmission of correction data is shown graphically in FIG. 2b. At a time t₁, the tropospheric corrections T are transmitted, directly followed at time t₂ by the ionospheric corrections I. Somewhat later, the hardware delay parameters B follow at time t₃. The subgroup of tropospheric and ionospheric parameters T, I is transmitted with a period T₁ (equal to time period T₂ in this case), and the hardware delay bias B with a period T₃. Of course, the update frequency of the parameters is the reciprocal of the period (fᵢ=1/Tᵢ).

### Mobile

According to the present invention embodiments, the mobile station or rover 30 is configured with software for real-time processing of GNSS receiver data and the received corrections B, and/or I and/or T. A mobile station 30 comprises a GNSS (e.g. GPS) receiver 32, an (optional) user interface unit 40, as well as a dedicated processing unit 38 for applying and implementing the method embodiments as described below. The processing unit 40 is arranged to receive the pseudo range mobile observations Pᵣ and carrier phase mobile observations Φᵣ from the GNSS receiver 32. The dedicated processing unit 38 co-operates with a separate receiving antenna 34 for receiving correction data A as transmitted by the GNS signal correction system 2. As shown in the embodiment of FIG. 1, the transmission of correction data A may be accomplished via an L-band transmission link using a communication satellite 33 and an L-band receiver 34. The receiver architecture of the mobile station 30 may then be less complicated as the receiving architecture for L-band signal processing is already present for the reception of GNSS signals.

The present invention embodiments provide a method and system to apply three types of corrections in mobiles. These corrections are properly received and decoded in the mobile station 30.

The present invention embodiments make use of the same functional model in the mobile side, therefore, the measurement model can be written as:

δ\tilde{p}_{i,r}^{s}=μᵣ^{s}Δxᵣ+mᵣ^{s}Tᵣ+tᵣ+γᵢĨᵣ^{s}

δ\tilde{φ}_{i,r}^{s}=μᵣ^{s}Δxᵣ+mᵣ^{s}Tᵣ+tᵣ+γᵢĨᵣ^{s}+λᵢa_{i,r}³ 924)

where μᵣ^{s} is is the unit vector of line-of-sight between the mobile receiver r and satellite s; δ\tilde{p}_{i,r}^{s}=p_{i,r}^{s}−Rᵣ^{s}+\tilde{b}ₛ, and δ\tilde{φ}_{i,r}^{s}=φ_{i,r}^{s}−Rᵣ^{s}+\tilde{b}ₛ, here Rᵣ^{s} is computed using precise orbits and a priori coordinates of receiver r, \tilde{b}^{s} is the precise satellite clock; Δxᵣ the correction to the a priori position. The remaining parameters are the same as in Eq.(10-11) and Eq. (16-17), except that the receiver index a or b is changed to r . The present invention embodiments select a reference satellite in the mobile to remove/eliminate receiver specific hardware delays. In this case, the functional model of the mobile is written as:

$$\begin{matrix}[ \begin{matrix}{P}_{1 , r} \\ {P}_{2 , r} \\ {Φ}_{1 , r} \\ {Φ}_{2 , r}\end{matrix} ] = [ \begin{matrix}{μ}_{r} & {M}_{r} & {e}_{n} & & & & {γ}_{1} {E}_{n \times ( n - 1 )} & & \\ {μ}_{r} & {M}_{r} & & {e}_{n} & & & {γ}_{2} {E}_{n \times ( n - 1 )} & & \\ {μ}_{r} & {M}_{r} & {e}_{n} & & {e}_{n} & & - {γ}_{1} {E}_{n \times ( n - 1 )} & {λ}_{1} {E}_{n \times ( n - 1 )} & \\ {μ}_{r} & {M}_{r} & {e}_{n} & & & {e}_{n} & - {γ}_{2} {E}_{n \times ( n - 1 )} & & {λ}_{2} {E}_{n \times ( n - 1 )}\end{matrix} ] [ \begin{matrix}Δ {x}_{r} \\ {T}_{r} \\ {t}_{{p}_{1} , r} \\ {t}_{{p}_{2} , r} \\ {t}_{{φ}_{1} , r} \\ {t}_{{φ}_{2} , r} \\ {I}_{r , sd} \\ {A}_{1 , r , sd} \\ {A}_{2 , r , sd}\end{matrix} ] \\ where & ( 25 ) \\ {μ}_{r} := {( \begin{matrix}{μ}_{r}^{1} & {μ}_{r}^{2} & … & {μ}_{r}^{n}\end{matrix} )}^{T} \\ {t}_{{p}_{1} , r} := {t}_{r} + {γ}_{1} {\tilde{I}}_{r}^{n} \\ {t}_{{p}_{2} , r} := {t}_{r} + {γ}_{2} {\tilde{I}}_{r}^{n} \\ {t}_{{φ}_{1} , r} := {t}_{r} - {γ}_{1} {\tilde{I}}_{r}^{n} + {a}_{1 , r}^{n} \\ {t}_{{φ}_{2} , r} := {t}_{r} - {γ}_{2} {\tilde{I}}_{r}^{n} + {a}_{2 , r}^{n} \\ {I}_{r , sd} := {( \begin{matrix}{\tilde{I}}_{r}^{1 , n} & {\tilde{I}}_{r}^{2 , n} & … & {\tilde{I}}_{r}^{n - 1 , n}\end{matrix} )}^{T} \\ {A}_{i , r , sd} := {( \begin{matrix}{a}_{i , r}^{1 , n} & {a}_{i , r}^{2 , n} & … & {a}_{i , r}^{n - 1 , n}\end{matrix} )}^{T} \\ {E}_{n \times ( n - 1 )} := ( \begin{matrix}{I}_{n - 1} \\ {0}_{n - 1}^{T}\end{matrix} ) = ( \begin{matrix}1 & & \\ & ⋱ & \\ & & 1 \\ 0 & … & 0\end{matrix} ) & ( 26 ) \\ {\tilde{I}}_{r}^{s , n} := {\tilde{I}}_{r}^{s} - {\tilde{I}}_{r}^{n} = {I}_{r}^{s} - {I}_{r}^{n} + \frac{{γ}_{1}}{{γ}_{1} - {γ}_{2}} ( - {d}_{{p}_{1}}^{s} + {d}_{{p}_{1}}^{n} + {d}_{{p}_{2}}^{s} - {d}_{{p}_{2}}^{n} ) & ( 27 ) \\ {a}_{1 , r}^{s , n} := {a}_{1 , r}^{s} - {a}_{1 , r}^{n} = {N}_{1 , r}^{s , n} - \frac{1}{{λ}_{1}} ( {d}_{{φ}_{1}}^{s , n} + \frac{{γ}_{1} + {γ}_{2}}{{γ}_{1} - {γ}_{2}} {d}_{{p}_{1}}^{s , n} - \frac{2 {γ}_{1}}{{γ}_{1} - {γ}_{2}} {d}_{{p}_{2}}^{s , n} ) & ( 28 ) \\ {a}_{2 , r}^{s , n} := {a}_{2 , r}^{s} - {a}_{2 , r}^{n} = {N}_{2 , r}^{s , n} - \frac{1}{{λ}_{2}} ( {d}_{{φ}_{2}}^{s , n} + \frac{2 {γ}_{2}}{{γ}_{1} - {γ}_{2}} {d}_{{p}_{1}}^{s , n} - \frac{{γ}_{1} + {γ}_{2}}{{γ}_{1} - {γ}_{2}} {d}_{{p}_{2}}^{s , n} ) & ( 29 )\end{matrix}$$

The functional model can be written in a simplified way. Assuming

$$y := [ \begin{matrix}{P}_{1 , r} \\ {P}_{2 , r} \\ {Φ}_{1 , r} \\ {Φ}_{2 , r}\end{matrix} ] , x := [ \begin{matrix}Δ {x}_{r} \\ {T}_{r} \\ {t}_{{p}_{1} , r} \\ {t}_{{p}_{2} , r} \\ {t}_{{φ}_{1} , r} \\ {t}_{{φ}_{2} , r} \\ {I}_{r , sd} \\ {A}_{1 , r , sd} \\ {A}_{2 , r , sd}\end{matrix} ]$$

The present invention embodiments provide a method to apply the corrections B to the phase observations,

$$y := [ \begin{matrix}{P}_{1 , r} \\ {P}_{2 , r} \\ {Φ}_{1 , r} - {λ}_{1} {E}_{n \times ( n - 1 )} {d}_{1 , a , sd} \\ {Φ}_{2 , r} - {λ}_{2} {E}_{n \times ( n - 1 )} {d}_{2 , a , sd}\end{matrix} ] \qquad ( 30 )$$

The parameter vector is then changed to

$$x := [ \begin{matrix}Δ {x}_{r} \\ {T}_{r} \\ {t}_{{p}_{1} , r} \\ {t}_{{p}_{2} , r} \\ {t}_{{φ}_{1} , r} \\ {t}_{{φ}_{2} , r} \\ {I}_{r , sd} \\ {N}_{1 , a , r} \\ {N}_{2 , a , r}\end{matrix} ] \qquad ( 31 )$$

where N_{i,a,r}=A_{i,r,sd}−d_{i,a,sd}=(N_{i,a,r}^{1,n} N_{i,a,r}^{2,n} . . . . N_{i,a,r}^{n-1,n})^{T}, in which, the hardware delays are removed, and ambiguities are the double-differenced ones between receiver r and master reference station a. The ambiguity term in the mobile has therefore an integer nature without containing hardware delay anymore, which meets the requirement to trigger an integer ambiguity estimation scheme, e.g. the LAMBDA method described in prior art.

The present invention embodiments provide a method to apply the corrections Ito the carrier phase and pseudo range observations

$$y := [ \begin{matrix}{P}_{1 , r} - {γ}_{1} {E}_{n \times ( n - 1 )} {I}_{sd} \\ {P}_{2 , r} - {γ}_{2} {E}_{n \times ( n - 1 )} {I}_{sd} \\ {Φ}_{1 , r} - {λ}_{1} {E}_{n \times ( n - 1 )} {d}_{1 , a , sd} + {γ}_{1} {E}_{n \times ( n - 1 )} {I}_{sd} \\ {Φ}_{2 , r} - {λ}_{2} {E}_{n \times ( n - 1 )} {d}_{2 , a , sd} + {γ}_{2} {E}_{n \times ( n - 1 )} {I}_{sd}\end{matrix} ] \qquad ( 32 )$$

The parameter vector can be changed as follows:

$$x := [ \begin{matrix}Δ {x}_{r} \\ {T}_{r} \\ {t}_{{p}_{1} , r} \\ {t}_{{p}_{2} , r} \\ {t}_{{φ}_{1} , r} \\ {t}_{{φ}_{2} , r} \\ δ {I}_{a , r} \\ {N}_{1 , a , r} \\ {N}_{2 , a , r}\end{matrix} ] \qquad ( 33 )$$

where δI_{a,r}=I_{r,sd}−I_{a,sd} is a residual ionospheric delay, which can be constrained, particularly in a small region. The residual ionospheric delay can be constrained to 1-2 cm, which will significantly reduce the time for estimating the correct integer values of N_{i,a,r}, and improve the accuracy of the estimated Δxᵣ.

The present invention embodiments provide a method to apply the corrections T to the carrier phase and pseudo range observations

$$y := [ \begin{matrix}{P}_{1 , r} - {γ}_{1} {E}_{n \times ( n - 1 )} {I}_{sd} - {M}_{r} {T}_{a} \\ {P}_{2 , r} - {γ}_{2} {E}_{n \times ( n - 1 )} {I}_{sd} - {M}_{r} {T}_{a} \\ {Φ}_{1 , r} - {λ}_{1} {E}_{n \times ( n - 1 )} {d}_{1 , a , sd} + {γ}_{1} {E}_{n \times ( n - 1 )} {I}_{sd} - {M}_{r} {T}_{a} \\ {Φ}_{2 , r} - {λ}_{2} {E}_{n \times ( n - 1 )} {d}_{2 , a , sd} + {γ}_{2} {E}_{n \times ( n - 1 )} {I}_{sd} - {M}_{r} {T}_{a}\end{matrix} ] \qquad ( 34 )$$

The parameter vector can be changed as follows:

$$x := [ \begin{matrix}Δ {x}_{r} \\ δ {T}_{r} \\ {t}_{{p}_{1} , r} \\ {t}_{{p}_{2} , r} \\ {t}_{{φ}_{1} , r} \\ {t}_{{φ}_{2} , r} \\ δ {I}_{a , r} \\ {N}_{1 , a , r} \\ {N}_{2 , a , r}\end{matrix} ] \qquad ( 35 )$$

where δT_{a,r}=Tᵣ−Tₐ is a residual tropospheric zenith delay, which can be constrained, particularly in a small region. The residual tropospheric zenith delay can e.g. be constrained to 1-2 cm, which will help to further reduce the time for estimating the correct integer values of N_{i,a,r}, and improve the accuracy of the estimated Δxᵣ.

The present invention embodiments make use of a mobile position xᵣ (Δxᵣ plus the a priori position) and the estimated coordinates of reference stations xₐ and x_{b} to calculate the baselines:

Δx_{a,r}=xᵣ−xₐ

Δx_{b,r}=xᵣ−x_{b}

As mentioned above, the position of the reference station 4a, 4b is calculated simultaneously with an accuracy of 10 cm. However, the precision of baselines can be a couple of millimetres as the double-difference ambiguities are fixed to their integer values, and the ionospheric/tropospheric effects are constrained at the mobiles. This is particularly suitable for applications as e.g. determination of a gunfloat position (a platform towed by a seismic vessel) with respect to the vessel. The distance between the gunfloat and the seismic vessel is about several hundreds of meters at most.

For such an application the secondary update frequency 1/T₁, 1/T₂ of the tropospheric and ionospheric corrections (T and I) may be made dependent on the distance between the one or more reference stations 4a, 4b and the mobile station 30. This allows a proper trade off of performance, bandwidth use, etc.

Even if a precise reference position is not available (but approximate coordinates with an accuracy of 1-2 meters instead, for example), e.g., due to a reset in the PPP process in the GNS signal correction system 2, the sum of all three types of corrections is still good enough to determine a precise relative position at the mobile station 30. However, in this case each individual bias B, I, T changes so quickly, that the biases B, I, T have to be transmitted together, i.e., at the same time and at the same interval. To that effect, and upon detection of an impossibility to reliably calculate the correction data B, I, T (at the reference station 4a, 4b for an epoch of received GNSS signals), the update intervals t₁, t₂, t₃ and secondary update frequency f₁, f₂, f₃ of the one or more subgroups B, I, T are synchronized (and possibly also intensified). A mechanism is then provided to detect such poor reference positions, e.g. variance-covariance of positions.

In an even further aspect, the present invention also relates to a mobile station for use with a GNS signal correction system, the mobile station 30 comprising a mobile GNSS receiver 32 for acquiring GNSS data comprising pseudo range mobile observations Pᵣ and carrier phase mobile observations Φᵣ from the plurality of GNSS satellites 26a-c transmitted over multiple epochs, a mobile signal receiver 34 for receiving GNSS corrections, wherein the mobile station 30 further comprises a mobile processing unit 38 connected to the mobile GNSS receiver 32 and the mobile signal receiver 34, the mobile processing unit 38 being arranged to use the correction data being transmitted according to any one of the embodiments described above. I.e. the mobile processing unit 38 is arranged to use the subgroups of correction data B, I, T, or if indication is received from the GNSS signal correction system 2 that a precise position is not available for an epoch, to use the sum of correction data.

The present invention embodiments have been described above with reference to a number of exemplary embodiments as shown in the drawings. Modifications and alternative implementations of some parts or elements are possible, and are included in the scope of protection as defined in the appended claims.

What is claimed is:

1. A method for providing correction data in a Global Navigation Satellite System based Precise Relative Positioning system, the method comprising:
determining the correction data using one or more reference stations, and
transmitting the correction data to a mobile station;
wherein the correction data comprises at least two subgroups of correction data, and wherein the at least two subgroups of correction data are transmitted with mutually different update frequencies.

2. The method according to claim 1, wherein the at least two subgroups of correction data comprise a first subgroup including tropospheric corrections transmitted with a first update frequency, a second subgroup including ionospheric corrections transmitted with a second update frequency, and a third subgroup including hardware delay bias transmitted with a third update frequency.

3. The method according to claim 2, wherein at least one of the first update frequency and the second update frequency is dependent on a distance between the one or more reference stations and the mobile station.

4. The method according to claim 2, wherein initial packets for the at least two subgroups of correction data are transmitted at mutually different initial update times.

5. The method according to claim 4, comprising:
synchronizing the initial update times and the update frequencies of the at least two subgroups of correction data, upon detection of an impossibility to reliably calculate the correction data.

6. The method according to claim 2, wherein the third update frequency is lower than the first update frequency and/or the second update frequency.

7. The method according to claim 6, wherein the third update frequency is less than once per twenty seconds.

8. The method according to claim 2, wherein the first update frequency is at least once per thirty seconds.

9. The method according to claim 2, wherein the second update frequency is at least once per twenty seconds.

10. The method according to claim 2, wherein the second update frequency and the first update frequency are different.

11. The method according to claim 1, wherein the one or more reference stations are dynamic reference stations.

12. The method according to claim 1, wherein the correction data are provided using a GNSS reference station, for which the position and other parameters are estimated using a Precise Point Positioning technique.

13. A Global Navigation Satellite (GNS) signal correction system for estimating and transmitting GNS signal corrections to a mobile station, the GNS signal correction system comprising:
one or more reference stations including a GNS receiver for acquiring GNS data including pseudo range system observations and carrier phase system observations from a plurality of satellites transmitted over multiple epochs;
a system processor unit configured for receiving the GNS data from the one or more reference stations in real time, and calculating correction data,
a system signal transmitter connected to the system processor unit for transmitting the correction data to the mobile station;
wherein the system processor unit is configured to execute the method according to claim 1.

14. A mobile station for use with Global Navigation Satellite (GNS) signal correction system, the mobile station comprising:
a mobile GNS receiver for acquiring GNS data including pseudo range mobile observations and carrier phase mobile observations from the plurality of satellites transmitted over multiple epochs,
a mobile signal receiver for receiving GNS corrections, wherein the mobile station further includes a mobile processing unit connected to the mobile GNS receiver and the mobile signal receiver,
the mobile processing unit being arranged to use correction data being transmitted according to the method of claim 1.
